(19) United States
(12) Patent Application Publication
(10) Pub. No.: US 2008/0162175 A1
(43) Pub. Date: Jul. 3, 2008

(54) System and method for enabling informed decisions

(76) Inventors: Todd Paige, Brunswick, ME (US); Mary Gale, Durham, NH (US); Shawn Smiley, Ocean side, CA (US); Jake Frederick, Portland, ME (US); Dana Hutchins, Portland, ME (US); Mabel Ney, New Gloucester, ME (US)

Correspondence Address: KUTA INTELLECTUAL PROPERTY LAW, LLC, P.O. BOX 380808, CAMBRIDGE, MA, 02238, US

(21) Appl. No.: 11/982,566

(22) Filed: Nov. 3, 2007

Related U.S. Application Data
(60) Provisional application No. 60/856,606, filed on Nov. 3, 2006.

(51) Int. Cl. G06Q 99/00

(52) U.S. Cl. 705/1

(57) ABSTRACT

An information system enables informed decisions based on personalized data. The system prompts a user for object specific data about an object at a basis of a decision, stores the object specific data, provides standards of care data, provides risk factors data, provides trusted general information and develops a personalized education program from the object specific data, standards of care data, risk factors data and trusted general information to enable a user to make an informed decision.

### CROSS-REFERENCES

This application claims priority of U.S. provisional application Ser. No. 60/856,606 filed Nov. 3, 2006 and titled “SYSTEM AND METHOD FOR CARE MANAGEMENT” by the present inventors, the entire content of which is incorporated herein by reference.

### BACKGROUND

People at times find themselves in situations where they need to make an informed decision about matters in which they have little or no expertise. These situations often arise in health care for pets as well as for humans. A visit to the office of the veterinarian or the physician may involve, for example, the need to understand a diagnosed condition and may further include a decision regarding a course of treatment. The matters involved can be complex and the health client may have little medical background or knowledge. Conventional solutions to this problem are often less then entirely effective.

For example, a visit to the office of the veterinarian may involve the need for the pet owner to understand a diagnosed condition of the pet and to decide from among several courses of action regarding treatment. Conventionally, in these instances, the veterinarian explains the diagnosis and the options for treatment. The pet owner may be provided with some visual or written materials if there are such materials available for the particular situation. The pet owner may also check the World Wide Web for guidance after he or she has left the vet appointment.

The conventional solutions to providing information for an informed decision can be inadequate. Written materials, if the office is equipped with a library, may include veterinary texts and treatises. The available books may not have information particular to the situation or the information may be too complex for the lay person. The written materials, alternatively, may include pamphlets written at the level of a person without medical background. The information in pamphlets, however, can quickly go out of date. Information on the Internet may be inaccurate and is typically not specific to the factors of the situation.

The result of applying conventional solutions at times leaves the veterinarian attempting to educate the pet owner with insufficient materials. In addition, health care professionals including veterinarians have time pressures requiring them to deal with client quickly, leaving them little time to explain conditions and treatments. Consequently, the results of a health care visit can include a failure to understand the health care problems, misunderstandings of all kinds, reluctance on the part of the pet owner to proceed with any course of action and a general feeling that good care was not provided.

The scenario described above plays out similarly in the physician's office with human patients. Alternatively, these situations may also arise in car maintenance and repair.

For the foregoing reasons, there is a need for a system to provide information and to enable client education with trusted, current data.

### SUMMARY

Embodiments of the present invention include a system for health care management that provides current information and specific information that enables an informed decision by the health care client. The system in a first embodiment includes a device for collecting data about a particular patient and a patient data storage device for storing patient data. The system further includes a database for storing health information, good health measures, disease information, disease risks, treatments, health recommendations and preventive measures. An engine processes input data, stored patient data and health information to enable an informed decision and to encourage compliance with a treatment program.

In alternative embodiments of the invention, middleware and software provides the ability for a pet owner to submit medical history data prior to a visit, participate in the diagnostic pathway of their pet, interact with unique and innovative content, and complete their clinic visit online using web based tools. Further, an exam room Learning Center enables veterinarians to speed the communication of important medical information in a multi media manner, using audio, visual and high quality three dimensional computer graphics models of dogs and cats that not only allows custom angled viewing of healthy orthopedic and physiological systems, but permits comparisons of healthy and sick pathologies in a standard and simple manner. In one arrangement, a touch screen module has an overview and six close ups of the common anatomical and physiological systems (Dermatology, Orthopedic, Internal Medicine, Ears, Eyes and Throat, Cardiac, Dental, for example) that veterinarians discuss daily with clients. Further, it has at least three pathologies per close up, for about 150 animated illustrations. In one alternative arrangement, a sponsor is enabled in the anatomy module.

Veterinarians currently do not have a web-based tool that can collect a standardized medical observation from pet owners. One embodiment of the present invention includes a tool that saves veterinarians time by enabling data collection and providing directed health information prior to the clinic visit. This tool has the advantages of standardizing pet owner health observations, increasing the efficiency of the clinic visit, and providing education to the pet owner but also enables clinics to recapture lost retail revenue that has migrated to the Internet, e.g., heartworm prevention. The pet owner is motivated by the present invention to entrust the pet's health care to the veterinarian.

In a further embodiment, the system includes a web site having a known user log so that history collection can be stored via cookie. The system further includes a framework and a collection of online medical records. In a further alternative embodiment, selected data captured via online observation form is aggregated and sold to customers in the industry for research and for marketing.

In another alternative embodiment, the system includes an exam room learning center. In one arrangement, the exam room learning center includes a personal computer with a touch screen interface that provides health care content via a Content Management System. The exam room learning center provides clients with a self guided learning experience in the exam room, and delivers an animated anatomy module. At anytime during the exploration of the Learning Center, a user can send a link to his or her home email address in order to continue learning from home. Further, the content at the exam room level is customizable, for example, based on selections made by the veterinarian at startup. For example, if a particular diet is preferred, the content at the exam room will provide that preferred information. Preferences can include health recommendations and can also include brand recommendation such as particular food brands. Food providers, for example, are able to advertise via the exam room learning center.

The present invention together with the above and other advantages may best be understood from the following detailed description of the embodiments of the invention illustrated in the drawings, wherein:

### DRAWINGS

FIG. 1 is a block diagram of an information system according to principles of the invention;

FIG. 2 is a block diagram of an anatomy subsystem implementable in the information system of FIG. 1;

FIG. 3 is a block diagram of an alternative embodiment of the information system of FIG. 1;

FIG. 4 is a flow chart showing the operation of the information system of FIG. 1;

FIG. 5 is an example output display according to principles of the invention;

FIG. 6 is a flow diagram showing the operation of one embodiment of the health care management system;

FIG. 7 is a flow diagram of a cat health assessment process implemented in an embodiment of the system of FIG. 1;

FIG. 8 is a flow diagram of a dog health assessment process implemented in an embodiment of the system of FIG. 1;

FIG. 9 is a block diagram of the top level view of the hit tracking system according to one embodiment of the invention;

FIG. 10 is a block diagram showing details of the kiosk upload subsystem (KUS) of FIG. 9;

FIG. 11 is a block diagram showing details of the web service interface between the kiosk and the web server of FIG. 9;

FIG. 12 is a block diagram showing details of the hit tracking processing service of FIG. 9;

FIG. 13 is a flow chart of the operation of the system of FIG. 9;

FIG. 14 is a flow chart of the process of recording hit data to the web server database in the system of FIG. 9; and

FIG. 15 is a flow chart of the process of the hit processor of the system of FIG. 9.

### DESCRIPTION

A system for client education provides current, trusted general information and specific information that enables an informed decision by the client. The system in a first embodiment is a health care system that includes a device for collecting data about a particular patient and a patient data storage device for storing patient data. The system further includes a database for storing health information, good health measures, disease information, disease risks, treatments, health recommendations and preventive measures. An engine processes input data, stored patient data and health information to provide personalized information to enable an informed decision and to encourage compliance with a treatment program.

In the following description, for the purposes of explanation, numerous specific details are set forth in order to provide a thorough understanding of the present invention. One skilled in the art will understand that the present invention may be practiced without some of these specific details. In addition, the following description provides examples, and the accompanying drawings show various examples for the purposes of illustration. These examples, however, should not be construed in a limiting sense as they are merely intended to provide examples of the present invention rather than to provide an exhaustive list of all possible implementations of the present invention. In other instances, well-known structures and devices are shown in block diagram form in order to avoid obscuring the details of the present invention.

Portions of the following detailed description may be presented in terms of certain processes and symbolic representations of operations on data bits. These process descriptions and representations are used by those skilled in the data processing arts to convey the substance of their work to others skilled in the art. An algorithm, as described herein, refers to a self-consistent sequence of acts leading to a desired result. The acts are those requiring physical manipulations of physical quantities. These quantities may take the form of electrical or magnetic signals capable of being stored, transferred, combined, compared, and otherwise manipulated. Moreover, principally for reasons of common usage, these signals are referred to as bits, values, elements, symbols, characters, terms, numbers, or the like.

These and similar terms are to be associated with the appropriate physical quantities and are merely convenient labels applied to these quantities. Unless specifically stated otherwise, it is understood that discussions utilizing terms such as “processing” or “computing” or “calculating” or “determining” or “displaying” or the like, refer to the action and processes of a computer system, or similar device, that manipulates and transforms data represented as physical (electronic) quantities within the computer system's devices into other data similarly represented as physical quantities within the computer system devices such as memories, registers or other such information storage, transmission, display devices, or the like.

The processes and displays presented herein are not inherently related to any particular computer or other apparatus. Various general purpose systems may be used with programs in accordance with the teachings herein, or it may prove convenient to construct more specialized apparatus to perform the specified method. For example, any of the methods according to the present invention can be implemented in hard-wired circuitry, by programming a general-purpose processor, or by a combination of hardware and software.

One of skill in the art will understand that the present invention can be practiced with computer system configurations other than those described below, including hand-held devices, multiprocessor systems, microprocessor-based or programmable consumer electronics, digital signal processing (DSP) devices, network PCs, minicomputers, mainframe computers, and the like. The invention can also be practiced in distributed computing environments where tasks are performed by remote processing devices that are linked through a communications network. Structures for a variety of these systems will appear from the description below.

It is to be understood that various terms and techniques are used by those skilled in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression.

Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment.

In one embodiment, the methods of the present invention are embodied in machine-executable instructions. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by a combination of programmed computer components and custom hardware components.

In one embodiment, the present invention may be provided as a computer program product which may include a machine or computer-readable medium having stored thereon instructions which may be used to program a computer (or other electronic devices) to perform a process according to the present invention. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

Accordingly, the computer-readable medium includes any type of media/machine-readable medium suitable for storing electronic instructions. Moreover, embodiments of the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

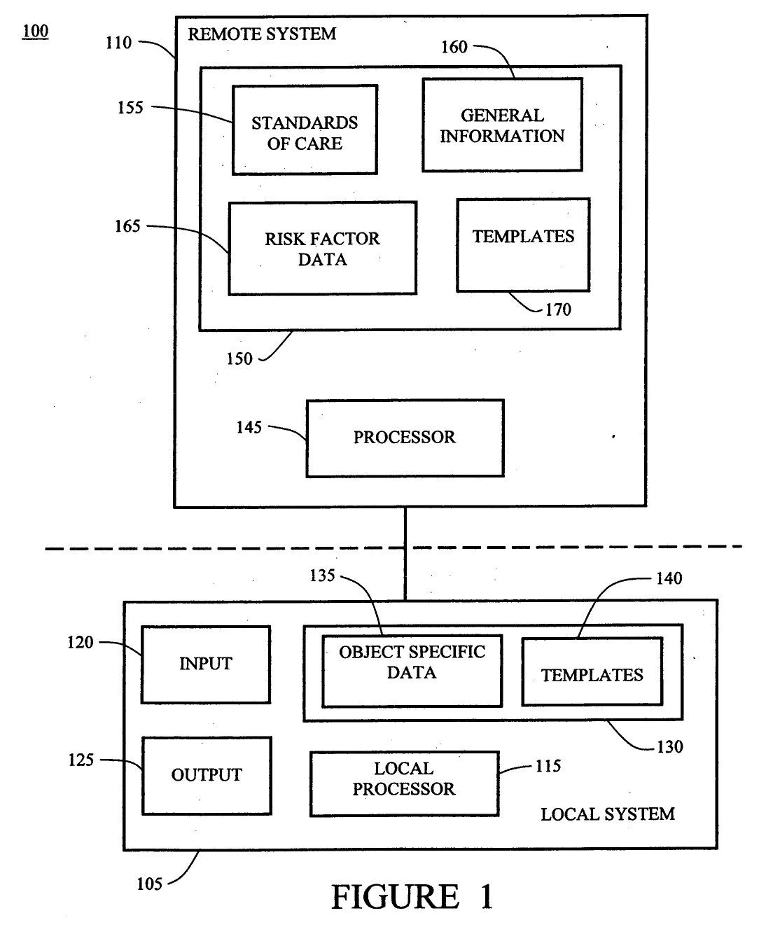

FIG. 1 shows a first embodiment of the information system 100 of the present invention. The system 100 includes a local system 105 that is located for example in a veterinary clinic, a physician's office or an auto repair shop. The system further includes a remote system 110 that is generally located away from the local system 105. The local system 105 and remote system 110 are in communication for example over a communications network. The communications network is for example the Internet. In an alternative embodiment, the communications network is a private network. Alternatively, the communications network is wireless. In a typical embodiment, many local systems are in communication with the remote system 100.

The local system 105 includes a local processor 115, an input device 120 and an output device 125 and a local storage system 130. One embodiment of the local system is a computer with input devices such as a keyboard and a mouse and an output device such as a visual display. The local storage system 130 includes object specific data 135 and templates 140. The object specific data 135 is for example patient data for an animal or a human. The patient data includes personal data such as address, medical history and data generated during an examination. In the case of an animal, the patient data includes for example breed. In the case of a human, the patient data includes family history. In an alternative embodiment in which the local system 105 is installed in an auto repair shop, the object specific data includes for example the address of the owner, the driving habits of the owner and past repairs as well as data generated in a present examination of the car. The templates 140, in various embodiments, are templates to enable standardization of data intake or standardization of storage or a combination of both.

The remote system 110, in a typical embodiment, is capable of serving many local systems, e.g., many veterinary practices, medical clinics, or auto repair shops. The remote system 110 includes a processor 145 and a storage device 150. The storage device 150 stores standards of care data 155, general information 160, risk factor data 165 and templates 170. The general information 160 is for example, physiology data and anatomy graphics, explanations of diseases or injuries, medical procedures and the like in the veterinary or medical clinic embodiments. The general information 160 in an alternative embodiment of the auto repair shop is automobile information including systems of the automobile and the workings of those systems. The general information 160 is preferably from one or more trusted sources. The general information 160 may for example be reviewed by experts for accuracy. The standards of care data 155 is information from one or more standards bodies describing current procedures such as medical procedures, outlines of standard tests or maintenance. The risk factor data 165 includes, in the veterinary or medical embodiment includes risk factors based on patient specific data such as age, breed or family history. The risk factor data 165 in other embodiments also includes risk factors according to geographic area such as areas where Lyme disease is prevalent. Other geographic risk factors include rabies or high incidence of influenza. The templates 170, in various embodiments, are templates to enable standardization of data intake or standardization of storage or a combination of both. All of the data including the standards of care 155, the general information 160, risk factor data 165 and templates 170 is updated regularly in order to keep the data current. The updates are made for example daily, however, may be made more or less frequently in order to maintain a current database. As described above, the information for the updates is obtained from trusted sources in order to maintain integrity of the information in the remote system. The templates 170 are maintained in a current format and distributed to the local system 105.

The system further includes a database for storing health information, good health measures, disease information, disease risks, treatments, health recommendations and preventive measures. An engine processes input data, stored patient data and health information to enable an output to the local system of comprehensive data set enabling an informed decision and to encourage compliance with a treatment program. The remote system further includes an anatomy subsystem able to generate anatomy illustrations and animations. In a first arrangement of the health care system, the anatomy subsystem provides anatomy information to the local system via a web link. In a second arrangement of the health care system, generated anatomy data is transmitted to the local system.

In operation, a data request including object specific data 135 is generated at the local system 105. The remote system 110 receives the data request and generates a response with information from the standards of care 155, general information 160 and risk factors data 165. The remote system 110 transmits the response to the local system 105 where it is provided, as for example, a displayed presentation or alternatively a print-out. In further alternative embodiments, the response is e-mailed to a user.

In a first example embodiment, the information system is a veterinary information system. The local system 105 is, for example, located in an exam room in the case of a veterinary but may also be located elsewhere such as the waiting area. The local system 105 includes an input device 120 for receiving patient data and system preferences. The local system 105 further includes an output device 125 for displaying or otherwise making available education materials and health care information. In some embodiments, the local system 105 is a simple input and output system transmitting data to and receiving data from the remote system. In some embodiments, a local management system manages data and further includes templates for data input and output, a data store for storing data and an engine performing similar operations to the engine located in the remote system.

The health information is updated regularly and so the users of the system are provided with access to current information even in fast-moving fields such as pet health care. Further, the stored health data includes customizing factors such as risk factor data by categories such as breed and residence location. If the pet, for example, is a German Shepherd dog living in an area having an identified tick problem, the remote system can output a data package including recommendations for dealing with canine hip dysplasia and a Lyme disease alert.

In an alternative embodiment, the remote system provides web site access accessible via the Internet from locations outside the veterinary office.

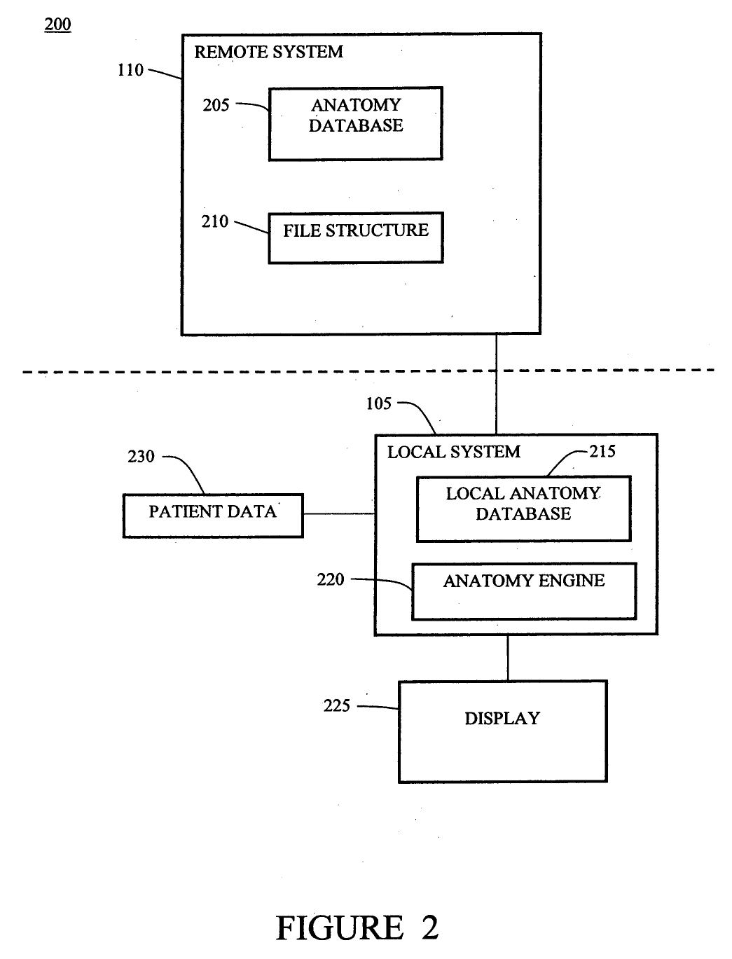

FIG. 2 is a block diagram of the anatomy subsystem 200 integratable into the information system 100 of FIG. 1. The remote server 110 in this embodiment includes an anatomy database 205 and a file structure 210. The anatomy database 205 and file structure 210 are for example included in the storage device 150. The local system 105 also includes a local anatomy database 215 and an anatomy engine 220. Attached to the local system is a display system 225 (although audible information is also provided in alternative embodiments). The local anatomy database 215 is updated with information from the anatomy database 205 from the remote system 110. As described above, the remote system 110 is updated regularly to maintain current information.

In a first example embodiment, the anatomy databases 205, 215 generally hold generic images of anatomy, for example, the images of healthy joints and organs. The anatomy database 205 at the remote server is the master database. The local system 105 downloads data from the remote server 110 to populate the local anatomy database 215. The download intervals are for example, once a day. The anatomy engine 220 in the local system 105 processes data from the local anatomy database 215 and also patient data 230 (included in the object specific data 135 for example) provided at the local system level to produce a display of, for example, side-by-side images of a healthy knee joint and an injured knee joint of the patient from the patient's data. The patient data is stored at the local level making it more secure and controllable by the veterinarian (or physician). Any one of a number of local storage systems may be used such as USB storage device or a CD or DVD. In alternative embodiments, the data is securely stored at the remote server so that the patient or medical specialists in other offices may access it away from the local system.

In an alternative embodiment of the system 200, the patient data 230 is stored in a provided file structure which in this embodiment is downloadable from the remote system 110. The standard formatting of patient data with the provided file structure 210 generally makes it more efficiently processed by the anatomy engine 220.

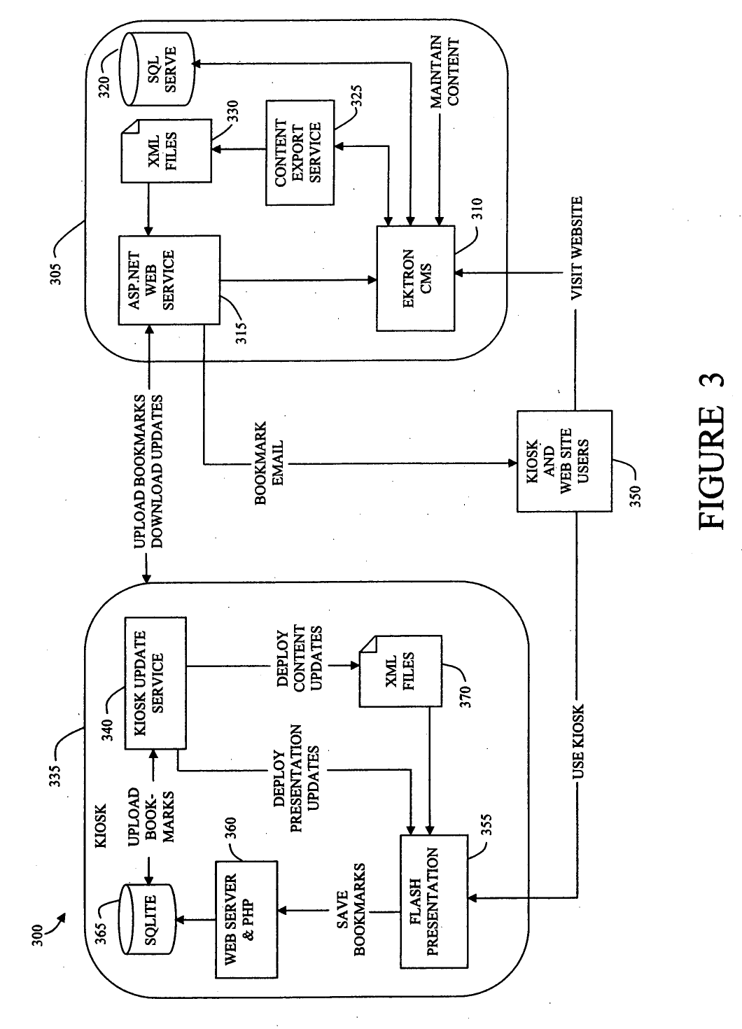

FIG. 3 shows another example embodiment of the information system of the present invention implemented in a setting such as in a veterinary clinic. In this embodiment, the remote system is implemented as a web site is hosted on a single HP ProLiant DL360 server 305. The server 305 includes dual Intel Xeon 3.0 GHz Processors, 4 GB of RAM, and 2×140 GB SCSI Hard Drives in a RAID 1 Array (not shown). The server 305 runs Suse Linux Enterprise 10.1 as its base operating system and uses VMWare Server to run instances of the Windows 2003 Server. The web site provides the veterinary staff with an easy to use interface for maintaining all of the content on the local system 335, referred to in this embodiment as kiosks.

The server 305 has five modules. These modules include the Ektron CMS 400.net content management system 310, an ASP.net web service 315, a SQL server 320, a content export service 325 and XML files 330. The Ektron CMS 400.net content management system (CMS) 310 powers the publicly visible portion of the web site and provides content management capabilities to the clinic staff. The ASP.net web service 315 provides a secure interface between the kiosk 335 and the server 305. The ASP.net web service 315 has interfaces that provide a kiosk update service 340 on the kiosk 335 with information on the current versions of content and application files so that the files can be updated. The ASP.net web service 315 also contains an interface for receiving and processing kiosk user bookmark requests. Bookmark requests are processed by temporarily storing the request in a local SQL Server 320 database until a personalized email message 345 can be generated and sent to the requesting visitor 350. In this embodiment, after the email is sent, the visitor's email address is removed from the local database. The content export service 325 periodically generates XML files 330 containing all of the kiosk content in the CMS 310. These XML Files 330 are downloaded by the kiosk 335 to display information to the kiosk users.

The CMS services, provided by the Ektron CMS 400.net Version 6.1, stores content in a Microsoft SQL Server 2005 database. Web services provided by the server 305 are built using Microsoft ASP.net Application Framework in C#. The content export service 305 is a Windows Service written in Microsoft C# 2.0. Application logging services in the web site and web services are provided by the Apache Organization's Log4Net Logging Framework. Database access in the web service is provided by the Apache Organization's iBatis Data Access Framework.

The local system 335, also referred to as a kiosk, in one arrangement, is a Tangent VITA 7500S All-in-One PC running Windows XP Professional. The kiosk 335 has five elements. These elements include a Macromedia Flash Presentation 355, web server and PHP 360, a Sqlite database 365, the kiosk update service 304 and local XML files 370. The Macromedia Flash Presentation 355 handles the display of information and user interaction on the kiosk. The content that the Flash Presentation 355 displays is stored in as XML files 370 on the kiosk hard drive. The XML files 370, in the present example embodiment, are updated daily with the latest content via the web site on the server 305 by the Kiosk Update Service 340. The Kiosk Update Service 340 is also responsible for downloading and deploying new versions of the Flash Presentation 355 as part of a daily system update. The local web server 360 runs the scripting language PHP that receives bookmark information from the Flash Presentation 355 when the user enters an email address. This bookmark information is cached in the local Sqlite database 365 until the Kiosk Update Service 340 can upload the request to the server 305 for processing. In the present embodiment, the bookmark request is removed from the local database once it has been successfully uploaded to the server 305.

The Flash Presentation module 355 is built using Macromedia Flash 8. The Kiosk Update Service 340 is built using Microsoft C# 2.0. The local web server 360 is the Abyss Web Server by Aprelium Technologies and uses PHP Scripts to write bookmark information to a local SQLite database 365. Application logging services in the Kiosk Update Service 340 are provided by the Apache Organization's Log4Net logging framework.

The implementation above is merely exemplary. Embodiments of the invention may be implemented in systems using other operating systems, alternative database formats and web software as well as alternative input/output systems. The present invention is not considered limited by the implementation described above.

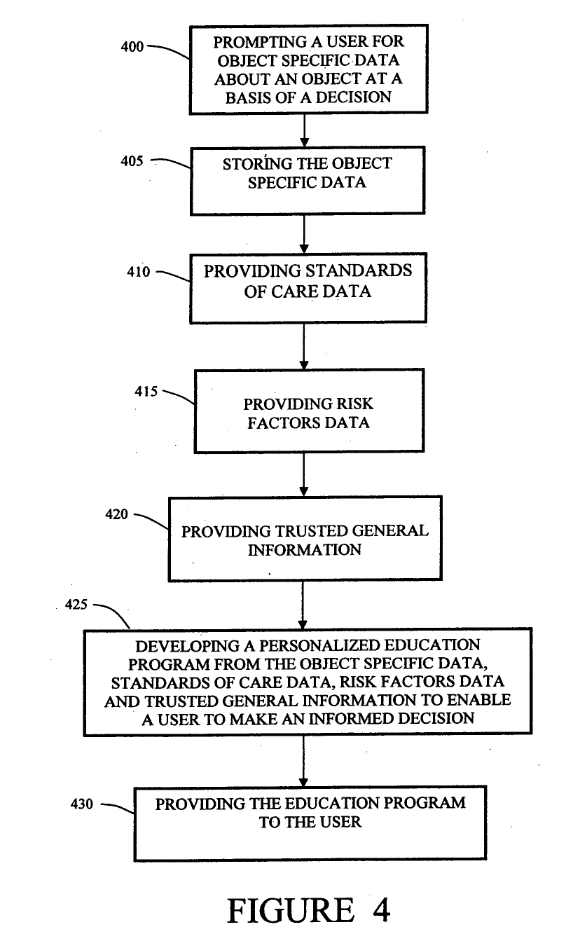

FIG. 4 is a flow chart of the operation of the information system of FIG. 1.

At step 400, the local system prompts a user for object specific data about an object at a basis of a decision. The user is for example a veterinary client, a medical patient, a car owner or someone entering information on behalf of a client. The object specific data includes for example, address, history data and results of a current examination. The problem is for example decision on a course of medical treatment or a car repair. These situations are merely exemplary. Use of the information system is not limited to those described here.

At step 405, the local system stores the object specific data. The information system, provides templates for standardizing the format of the data. Standardization aids efficiency of storage. Standardization also enables the information system to process requests.

At step 410, the information system provides standards of care data. The standards of care data, as described above, includes information from one or more standards bodies describing current procedures such as medical procedures, outlines of standard tests or maintenance. The standards of care data is updated regularly such that the data is current.

At step 415, the information system providing risk factors data. The risk factors data, as described above, includes, in the veterinary or medical embodiment, risk factors based on patient specific data such as age, breed or family history. The risk factor data in other embodiments also includes risk factors according to geographic area such as areas where Lyme disease is prevalent. Other geographic risk factors include rabies or high incidence of influenza or drinking water issues.

At step 420, the information system provides trusted general information. As described above, the general information includes physiology data and anatomy graphics, explanations of diseases or injuries, medical procedures, or automobile information and graphics.

At step 425, the information system develops a personalized education program from the object specific data, standards of care data, risk factors data and trusted general information to enable a user to make an informed decision. For example, if the user is faced with a decision regarding which health regimen to follow given a particular medical condition, the information system provides a set of information describing the condition, each of the options and information regarding the risk factors specific to the user given the provided object specific data.

At step 430, the information system provides the education program to the user. In one embodiment, the information is provided as a display at for example, in a veterinary exam room or a doctor's office. In an alternative embodiment, the information is provided in an e-mail to the user. In this embodiment, the user is able to access the information repeatedly and in a setting of the user's choosing and at times of user convenience.

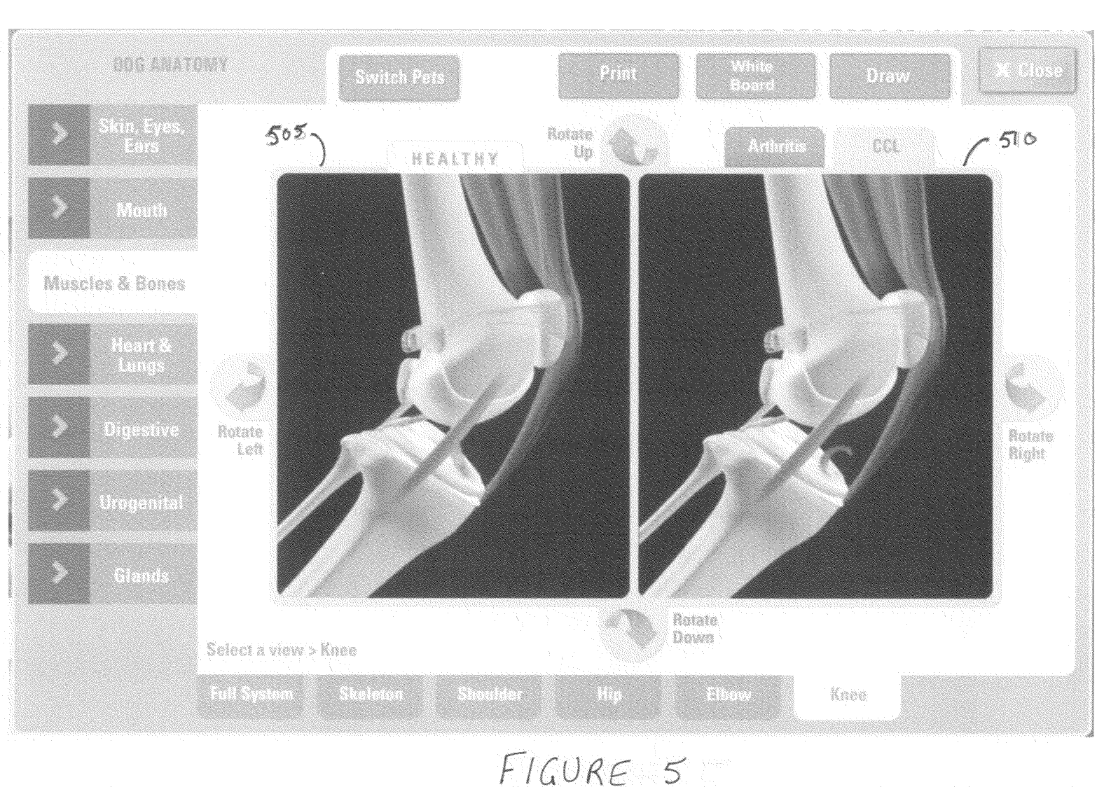

FIG. 5 is an example anatomy subsystem display showing a dog anatomy view having a first image 505 of a healthy joint is shown next to a second image 510 of a sick joint. This display provides the user with a comparison view to enable understanding of a condition such as a torn ligament. In a first arrangement of the invention, the images are generic. In a second arrangement, the illustrations are pet-specific. For example, if the dog has one healthy joint and one sick joint, the two joints can be displayed together. Alternatively, the first image is a generic image and the second is an image specific to the dog being examined. In this way, the owner can understand the condition specific to his or her pet.

In a further alternative embodiment of the system, the anatomy views shown above are not static views but rather can be rotated so that the subject matter can be viewed from a plurality of angles. In one alternative embodiment of the invention, the view is an animation so that the user can see the joint or other particular anatomical portion in movement.

In other embodiments of the system, the anatomy is human anatomy. In still further alternative embodiments of the system, the “anatomy” is car information including images of car parts and systems. Those skilled in the art will understand that other types of information are within the scope of the present invention.

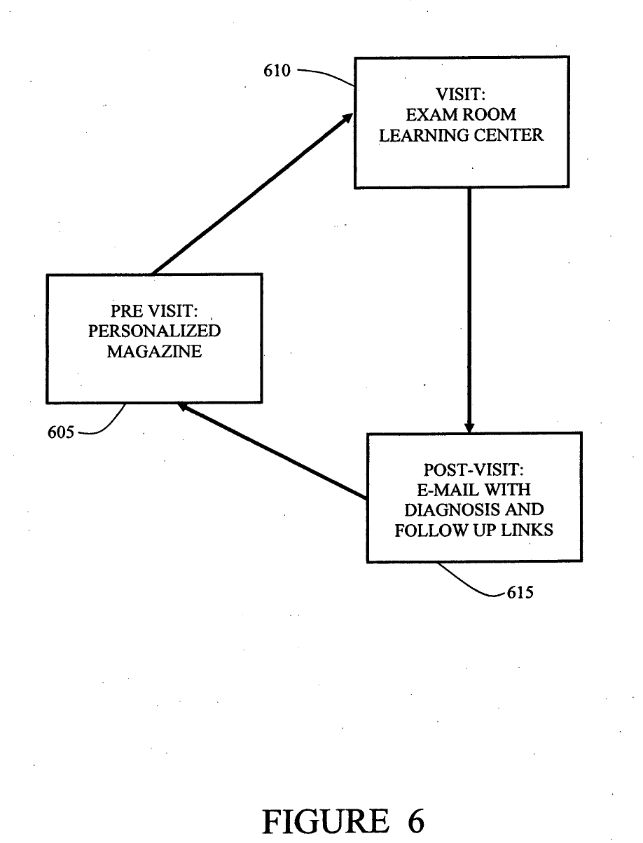

FIG. 6 is an example flow of operations of the information system according to one embodiment such as a health care management system. In this embodiment, the health care client, that is, the pet owner, receives previsit materials which in various arrangements can include a personalized magazine or newsletter providing information about the visit and general information about animals as well as vendor information, step 605. The magazine content is not limited to the description provided above. In the exam room, the local system operates as a learning center to provide a template for the user to enter his or her observations regarding the pet, step 610. After the visit, the health care management system provides follow-up information through e-mail and web links so that the user may continue the education process after the visit, step 615. This also provides the user with the opportunity to review information already provided for greater understanding.

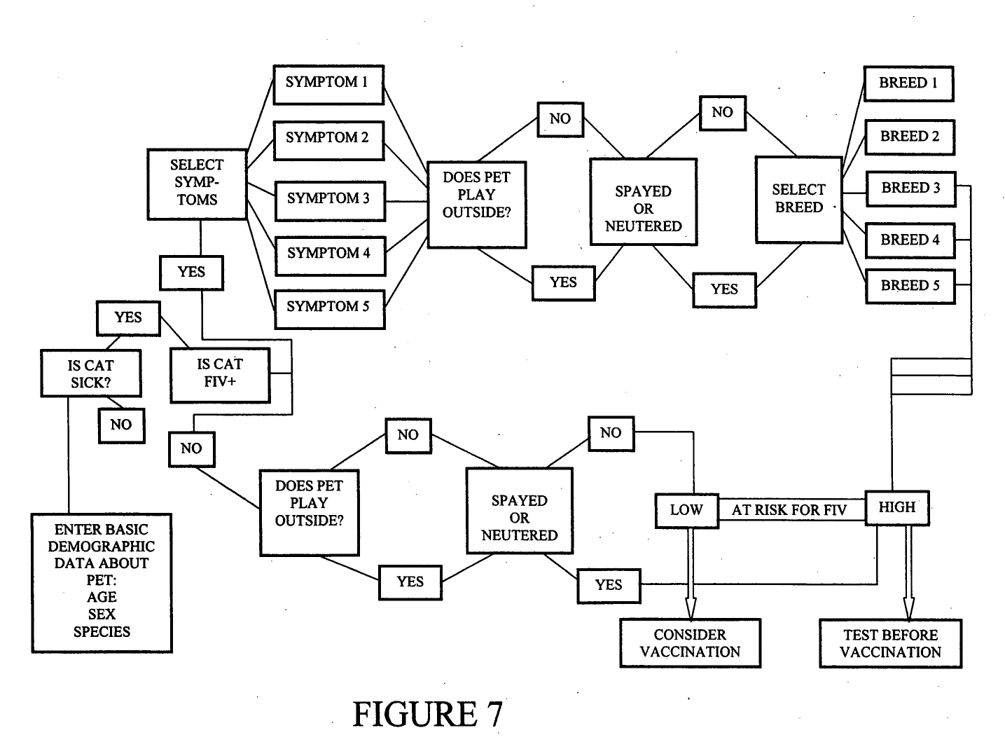

FIG. 7 is a flow diagram of a cat health assessment process implemented in an embodiment of the system of FIG. 1. The flow diagram shows intake of data and a resulting assessment based on the data input. This exemplary assessment illustrates only one example process used by the information system 100 to develop a personalized education program using object specific data. The information system in one embodiment uses only one assessment. In an alternative embodiment, the information system 100 uses more than one assessment.

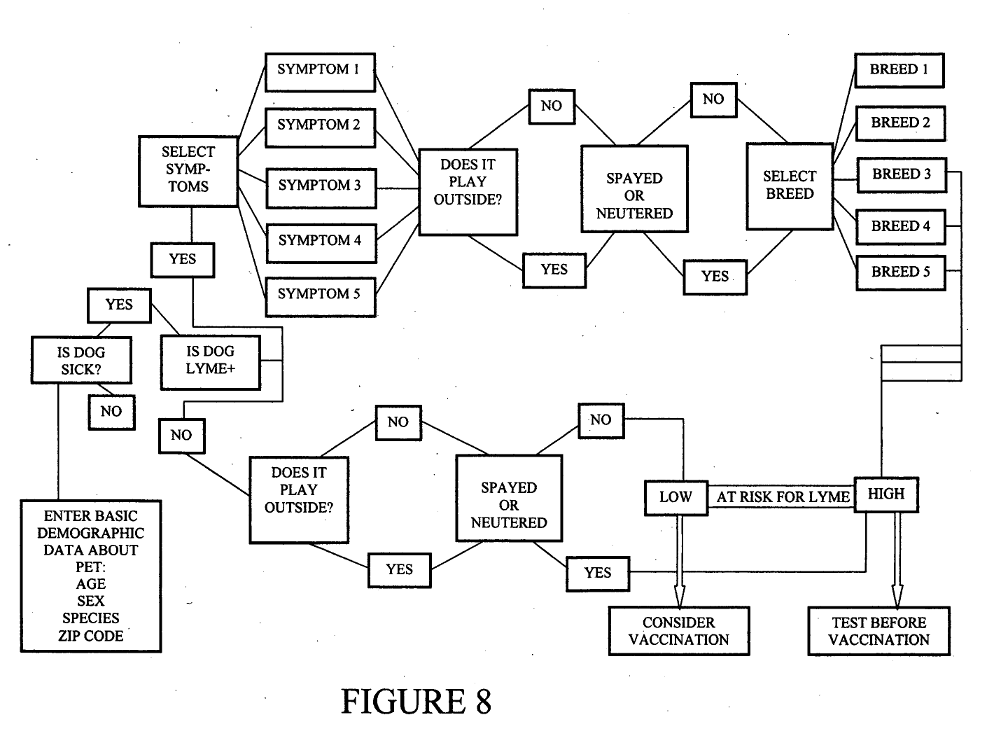

FIG. 8 is a flow diagram of a dog health assessment process implemented in an embodiment of the system of FIG. 1. The flow diagram shows intake of data and a resulting assessment based on the data input. This exemplary assessment illustrates only one example process used by the information system 100 to develop a personalized education program using object specific data.

The health assessments of FIG. 7 and FIG. 8 are merely exemplary. The present invention is not considered to be limited to these assessments. Any number of health protocols and assessments may be implemented in the health care management system.

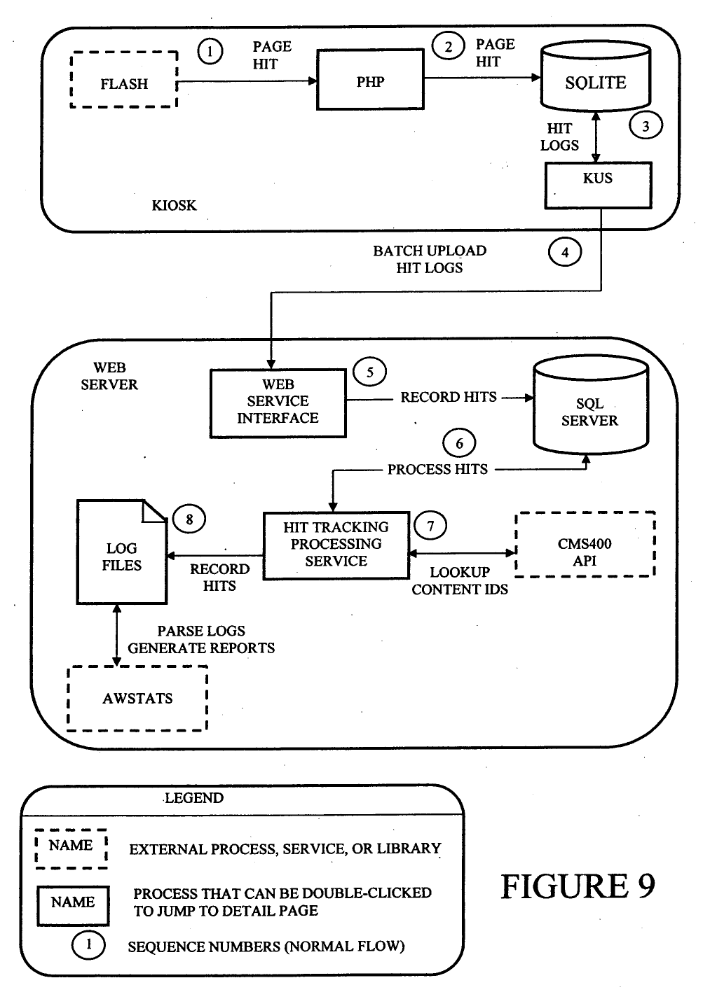

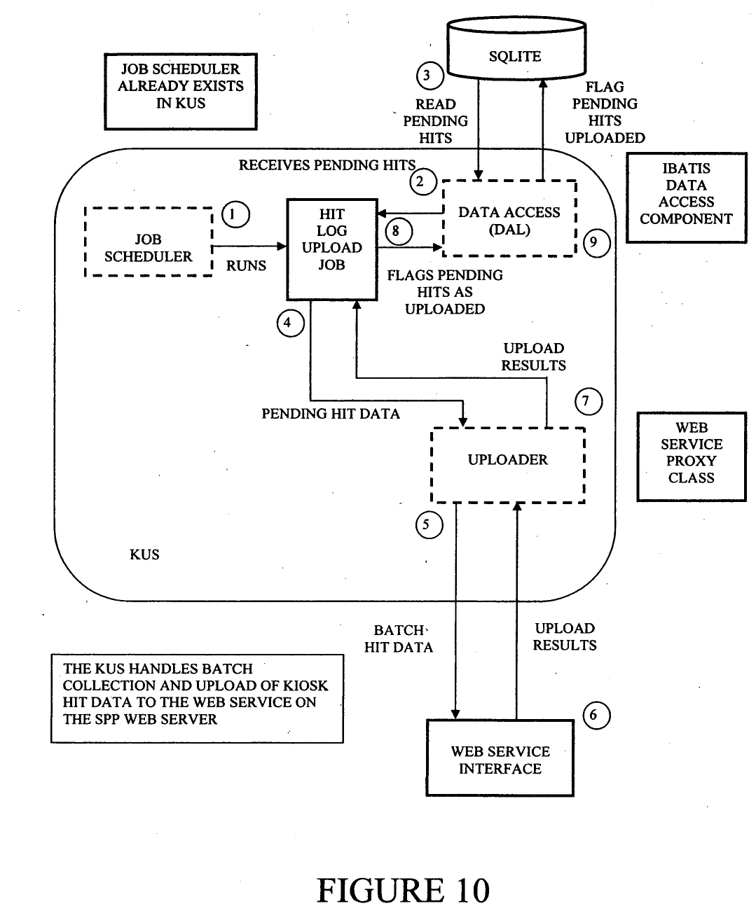

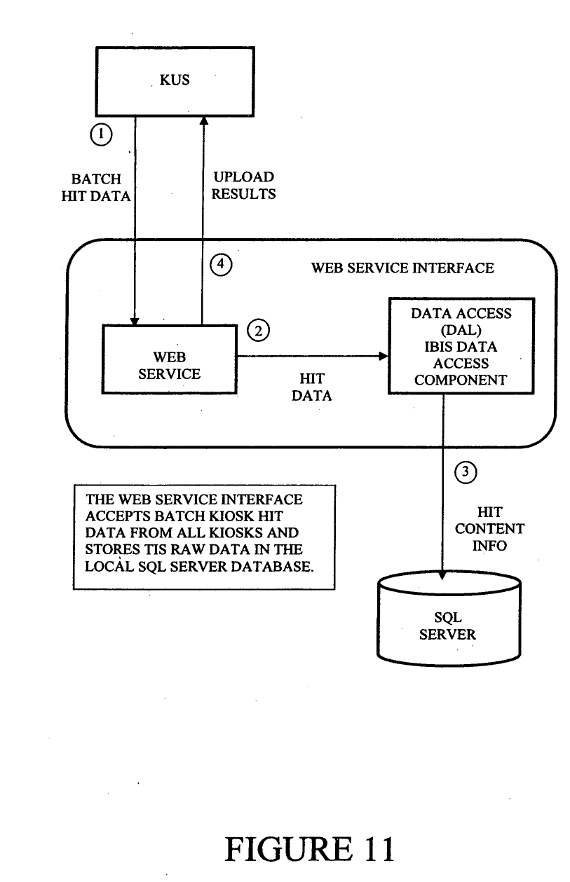

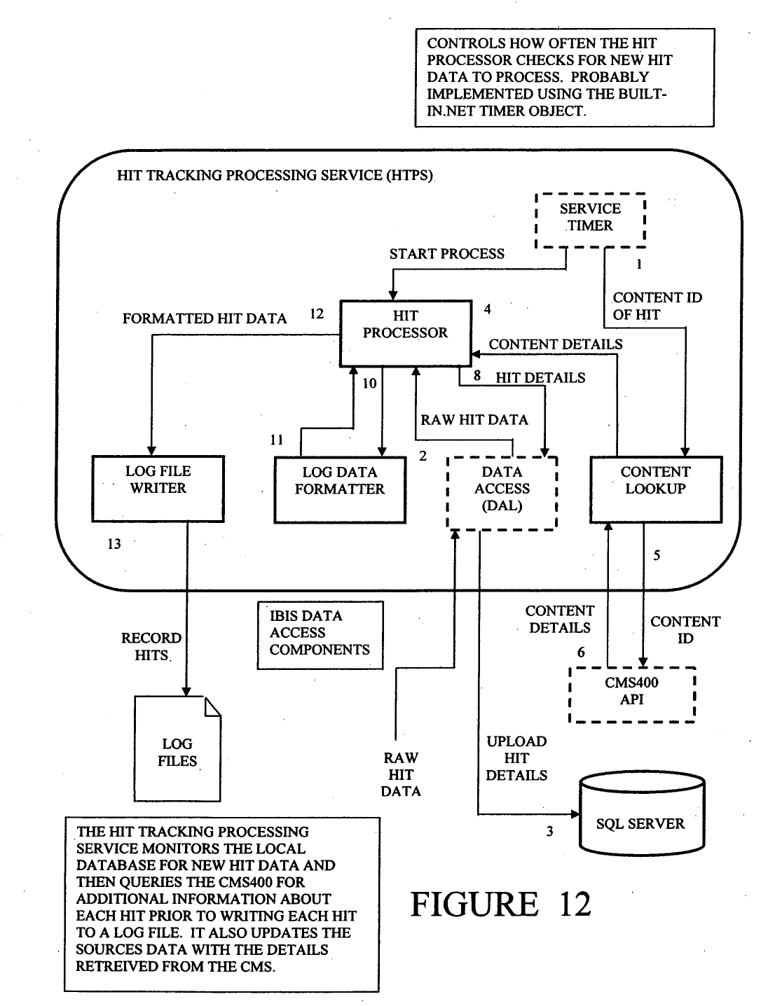

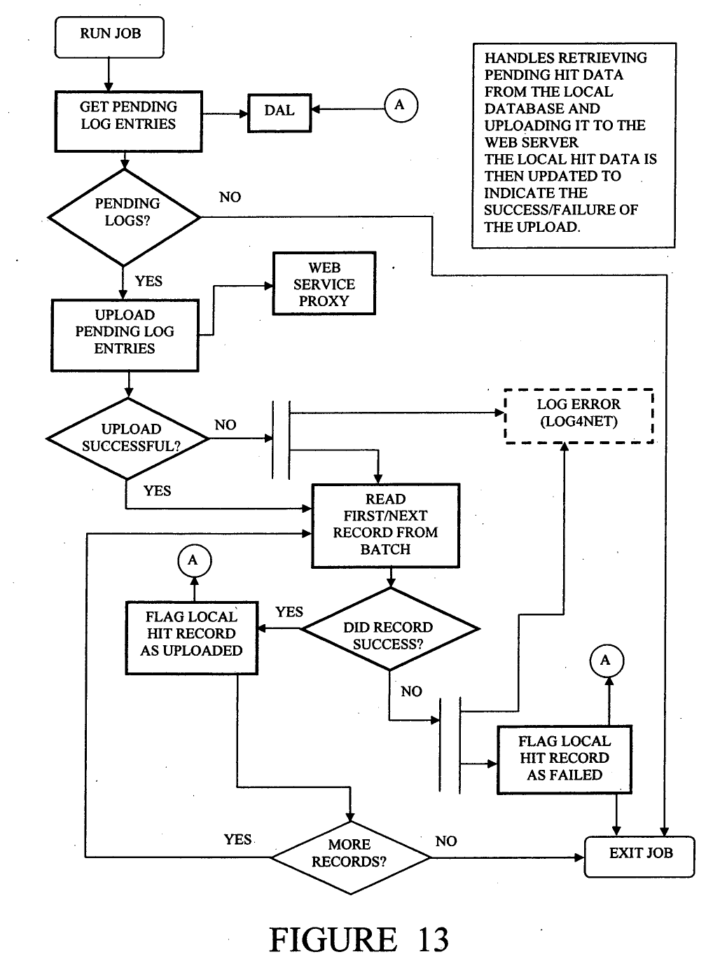

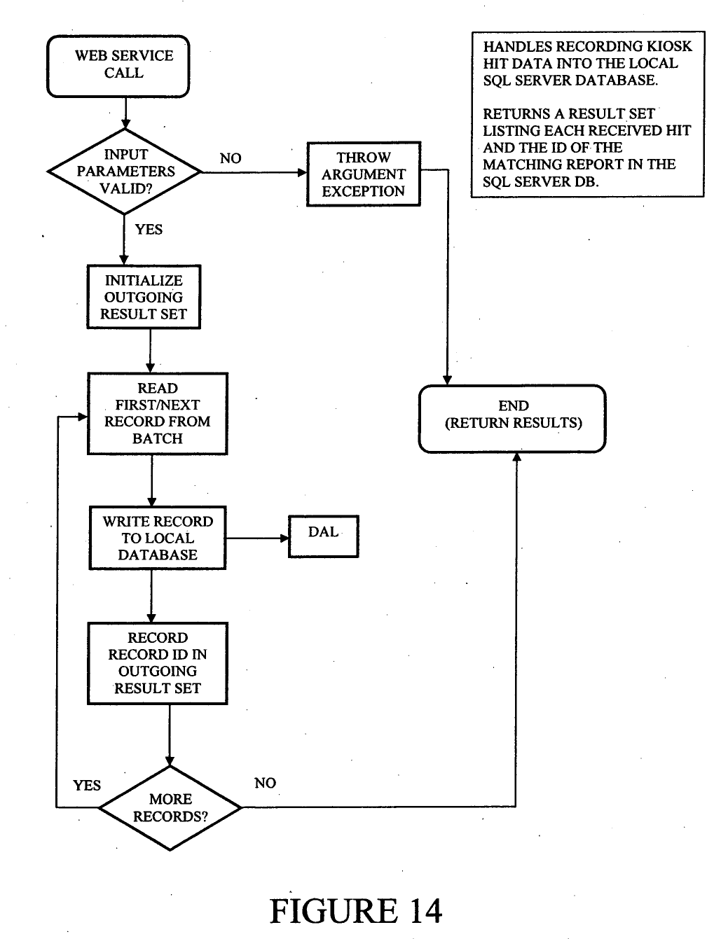

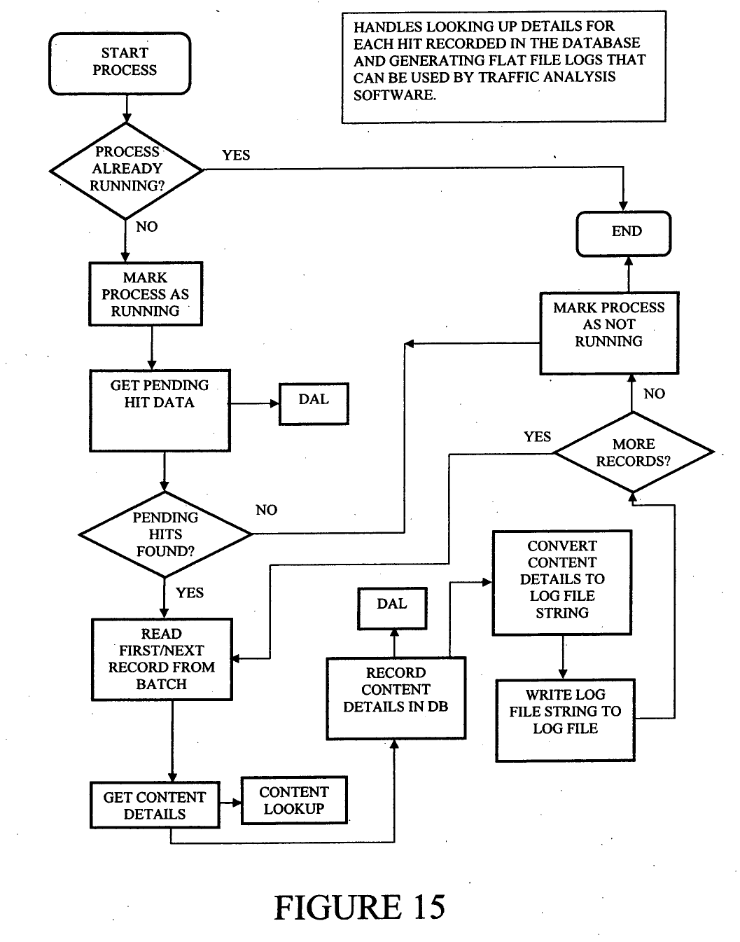

FIGS. 9-15 show the system and operations of a hit tracking system usable in one embodiment of the invention. FIG. 9 is a block diagram of the top level view of the hit tracking system according to one embodiment of the invention. FIG. 10 is a block diagram showing details of a kiosk upload subsystem (KUS) of the hit tracking system. FIG. 11 is a block diagram showing details of the web service interface between the kiosk and the web server in accomplishing hit tracking. FIG. 12 is a block diagram showing details of the hit tracking processing service. FIG. 13 is a flow chart of the operation of the hit tracking system. FIG. 14 is a flow chart of the process of recording hit data to the web server database in the hit tracking system. FIG. 15 is a flow chart of the process of the hit processor of the hit tracking system.

The hit tracking system tracks user usage of the kiosk including for example pages viewed and data accessed and entered. Each time a user accesses a page, a hit is recorded. In this example embodiment, each hit activates a portion of a flash program associated with the accessed page. The program generates a message containing an identification code of the accessed content. The messages in this embodiment are batched locally on the kiosk and then uploaded and processed at the web server. The embodiment provided in FIGS. 9-15 is merely exemplary. Variations of the data collection and processing portions, for example, are considered to be within the scope of the invention.

Embodiments of the of the health care management system include in-exam room pet owner education delivered via a computerized learning center or web-enabled kiosk portal. The system enables compliance to standard-of-care health regimes. Embodiments of the system include vaccine risk assessment and needs. Further the system provides standardized medical history collection. In addition, the health care management system provides a controlled information portal so that the user is provided with known accurate information. Further alternative embodiments of the system include a dynamic, in-exam room kiosk that enables consistent medical history collection and assessments which assist the veterinarian in offering proper care while providing veterinarian-sanctioned education content. This content in one arrangement is offered in the exam room. In another arrangement, the content is also offered at the reception desk or in the waiting room. The system further provides for health vendor sponsorship through various advertising revenue business models including content sponsorship and pay per click.

It is to be understood that the above-identified embodiments are simply illustrative of the principles of the invention. Various and other modifications and changes may be made by those skilled in the art which will embody the principles of the invention and fall within the spirit and scope thereof.

What is claimed is:

1. A method for enabling informed decisions, comprising:
prompting a user for object specific data about an object at a basis of a decision;
storing the object specific data;
providing standards of care data;
providing risk factors data;
providing trusted general information; and
developing a personalized education program from the object specific data, standards of care data, risk factors data and trusted general information to enable a user to make an informed decision.

2. The method of claim 1 wherein the education program includes a visual presentation of a problem-free part and an impaired part.

3. The method of claim 1 wherein the step of storing the object specific data comprises storing the object specific data in a standard form.

4. The method of claim 1 wherein the risk factors data includes geographic risk factors.

5. The method of claim 1 wherein the object is an animal and the risk factors data includes animal breed.

6. The method of claim 1 wherein the object is a human and the risk factors data includes family history.

7. The method of claim 1 wherein the object is an automobile.

8. The method of claim 1 further comprising updating standards of care data daily and updating risk factors data daily.

9. The method of claim 1 further comprising providing the education program in an independently accessible form.

10. A system for enabling informed decisions, comprising:
a processor;
an input device in communication with the processor for receiving object specific data;
a storage device in communication with the processor, the storage device storing the received object specific data, standards of care data, risk factors data and trusted general information,
wherein the processor analyzes the object specific data with regard to the standards of care data and risk factor data to develop a personalized education program using the trusted general information.

11. The system of claim 10 further comprising an output device, the output device to provide a view of a problem-free part and an impaired part.

12. The system of claim 10 wherein the storage device stores the object specific data in a standardized form.

13. The system of claim 10 wherein the risk factors data includes geographic risk factors.

14. The system of claim 10 wherein the risk factors data includes animal breed.

15. The system of claim 10 wherein the risk factors data includes family history.

16. A distributed system for enabling informed decisions, comprising:
a remote system having a storage device storing standards of care data, trusted general information, and risk factor data, the remote system having an engine in communication with the storage device, the remote system adapted to receive data requests, the engine to develop a response to the data requests;
a local system in communication with the remote system, the local system having a processor, an input device in communication with the processor, a local storage device in communication with the processor, the local storage device storing object specific data,
wherein the local system transmits an information request including a portion of object specific data of a selected object, the remote system responds to the information request with an education program personalized for the selected object thereby enabling an informed decision.

17. The distributed system of claim 16 wherein the education program includes health care risks.

18. The distributed system of claim 16 wherein the risk factor data includes risks according to geographic area.

19. The distributed system of claim 16 wherein the remote system stores at least one template, the local system downloads the at least one template and stores object specific data in a standardized way using the at least one template.

20. The distributed system of claim 16 wherein the remote system transmits risk alerts to the local system.

21. The distributed system of claim 16 wherein the local system further comprises a visual display, the processor to generate a view including a first image of a problem-free part and a second image of an impaired part.
